(19) United States
(12) Patent Application Publication
(10) Pub. No.: US 2026/0186631 A1
(43) Pub. Date: Jul. 2, 2026

(54) Systems and Methods for Automatic Document Navigation

(71) Applicant: Freyr, Inc., Princeton, NJ (US)

(72) Inventors: Praveen Kumar Bezawada, Tampere (FI); Yan Qiao Gai, Chengdu (CN); Hao Liu, Chengdu (CN); Qi Rui Chen, Chengdu (CN)

(73) Assignee: Freyr, Inc., Princeton, NJ (US)

(21) Appl. No.: 19/328,078

(22) Filed: Sep. 12, 2025

Related U.S. Application Data
(60) Provisional application No. 63/738,899, filed on Dec. 26, 2024.

(51) Int. Cl. G06F 3/0484; G06F 40/134; G06F 40/30

(52) U.S. Cl. CPC G06F 3/0484; G06F 40/134; G06F 40/30

(57) ABSTRACT

Methods and systems for a scalable, efficient, artificial intelligence-assisted method for automating the generation, validation, and quality control of bookmarks, hyperlinks, or other navigational elements in complex documents or collections of documents. An appropriate document template may be identified, navigational elements may be generated and inserted into the documents or collections of documents, and compliance verification may be performed. The system can thus ensure completeness, accuracy, and adherence to regulatory or industry standards, minimizing or eliminating the need for manual intervention.

### RELATED APPLICATIONS

The present application claims the benefit of and priority to U.S. Provisional Patent Application No. 63/738,899 , entitled “Systems and Methods for Automatic Document Navigation,” filed Jan. 9, 2025, the entirety of which is incorporated herein by reference.

### FIELD OF THE DISCLOSURE

This disclosure generally relates to systems and methods for data processing. In particular, this disclosure relates to systems and methods for automatic generation and verification of bookmarks, hyperlinks, or other navigational elements in documents.

### BACKGROUND OF THE DISCLOSURE

Many types of documents can incorporate internal navigation elements, such as bookmarks, hyperlinks (both to other sections within the document or to external documents), or other such elements. However, manually adding these may be tedious, particularly with very long and intricate documents. For example, some standards documents may include hundreds or even thousands of subheadings or subsections, as well as tables, figures, etc., requiring many hours of work to add links and create an index. Such manual efforts are frequently error prone, with missed sections, misplaced links or links with wrong addresses, etc.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a logical diagram of a system for automatic generation and verification of document navigational elements, according to some implementations;

FIG. 2 is an activity diagram of a method for automatic generation and verification of document navigational elements, according to some implementations;

FIG. 3 is a block diagram of a scalable computing system for automatic generation and verification of document navigational elements, according to some implementations;

FIG. 4 is a block diagram of a cognitive agent, according to some implementations;

FIG. 5 is a functional diagram of a compute framework for automatic generation and verification of document navigational elements, according to some implementations;

FIG. 6 is a diagram of an example of generation of an agentic workflow for data processing, according to some implementations;

FIGS. 7A and 7B are data flow diagrams of examples of agentic workflows for automatic generation and verification of document navigational elements, according to some implementations;

FIG. 8 is a flow chart of a method for automatic generation and verification of document navigational elements, according to some implementations;

FIG. 9 is another flow chart of a method for automatic generation and verification of document navigational elements; and

FIGS. 10A and 10B are block diagrams depicting embodiments of computing devices useful in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for automatic document navigation; and
Section B describes a computing environment which may be useful for practicing embodiments described herein.

### A. Systems and Methods for Automatic Document Navigation

Many types of documents can incorporate internal navigation elements, such as bookmarks, hyperlinks (both to other sections within the document or to external documents), or other such elements. However, manually adding these may be tedious, particularly with very long and intricate documents. For example, some standards documents, regulatory documents (e.g. a chapter of the Code of Federal Regulations), clinical trial study report documents, telecommunications standards, pharmaceutical testing documents, etc., may include hundreds of even thousands of subheadings or subsections, as well as tables, figures, etc., requiring many hours of work to add links and create an index.

Publishers face significant challenges in ensuring that all hyperlinks, bookmarks, Table of Contents (ToC) entries, or other navigation elements navigate accurately to the correct sections of destination documents. Manual verification processes often result in overlooked errors, especially in large, complex documents, and can result in missed sections, misplaced links or links with wrong addresses, etc. Furthermore, documents may have formatting requirements or style guidelines (e.g., blue text for hyperlinks, inherited zoom for bookmarks, etc.) that vary between document types according to manuals or source templates. Manual processes make it challenging to ensure uniformity, especially when handling multiple document formats.

In addition to varying formatting and style, documents may have different contexts or specific terminology that needs to be considered to accurately create navigational elements. For example, legal documents may have specific definitions for words placed elsewhere in the document that should be linked, while this may be confusing or unnecessary for a pharmaceutical document. Conversely, a reference to a proprietary pharmaceutical name may require linking to a nonproprietary version, such as the proprietary “Tylenol” and the nonproprietary “acetaminophen”. As a result, publishers have had to manually create these navigational elements using their personal subject matter-specific knowledge, further leading to errors and inconsistent navigation. Publishers also need to ensure that link properties (e.g., new window, page magnification) are in line with approved specifications, which further adds complexity to the publication and review process.

Furthermore, manual processes are not scalable and are inefficient during periods of high document volume, negatively impacting turnaround times and quality. The manual nature of hyperlink and bookmark generation and quality control becomes a bottleneck when handling large numbers of documents or time-sensitive submissions. For example, once links or other navigation elements are added, current quality control practices require users or publishers to review documents page by page and manually check hyperlinks and bookmarks against approved checklists. This repetitive, labor-intensive process increases the likelihood of errors, leading to discrepancies in link accuracy and formatting across documents. The manual nature of the hyperlink and bookmark generation process, combined with inefficient quality control methods, affects both turnaround time and the quality of document outputs. This is especially problematic in regulatory environments where accuracy, consistency, and adherence to specifications are critical for compliance.

Efforts to automate generation of these navigation elements have been naive. That is, conventional computing systems fail to consider the document type, section types, semantic context, relations between sections, etc. when attempting to dynamically create navigational elements within or between documents. For example, automated keyword-based linking (e.g. using terms like “figure” or “section”) or format-based linking (e.g. using bullet points or multi-level lists) may be both over-inclusive (e.g. treating every subheading or bullet point as a unique link) and under-inclusive (e.g. missing context-specific requirements such as the above-mentioned legal definitions or pharmaceutical name correspondences). Accordingly, users are still required to manually add and manipulate navigational elements in order to create properly organized documents.

Implementations of the systems and methods discussed herein solve these and other problems in the electronic publishing industry by leveraging the use of machine learning and artificial intelligence systems, including large language models (LLMs) for semantic and contextual analysis and document parsing and code generation that complies with regulatory standards or other requirements. These implementations provide an improvement in automated generation, validation, and quality control of navigation elements such as bookmarks and hyperlinks, ensuring accurate navigation and consistent formatting across documents to enable compliance and improve overall document quality. The automation reduces manual effort, accelerates document processing, and ensures scalability for handling large document volumes. Implementations of these systems and methods may integrate seamlessly into existing publishing workflows, offering faster, more reliable document preparation in high-volume environments.

In some implementations, the systems and methods discussed herein provide an AI-assisted method for automating the generation, validation, and quality control (QC) of bookmarks, hyperlinks, and Table of Contents (ToC) in complex documents. In some implementations, the system utilizes artificial intelligence to identify the appropriate document template and verify that all required sections, headings, and navigational elements are present and correctly formatted. By comparing the document to predefined templates, the system can ensure completeness, accuracy, and adherence to regulatory or industry standards, minimizing or eliminating the need for manual intervention,

In some implementations, these systems also automate the generation of bookmarks and hyperlinks by analyzing the document's structure and context. In some implementations, the system identifies key elements such as sections, figures, and tables, and automatically creates accurate internal and external navigational elements. These elements are aligned with the document's formatting requirements and contextual references, ensuring that they are placed correctly and meet industry-specific standards, such as those required for regulatory submissions.

In addition, in some implementations, the system provides automated validation of all bookmarks and hyperlinks, checking for errors such as broken links, incorrect destinations, or formatting issues. The system may identify and resolve duplicate or overlapping hyperlinks, ensuring that only the correct and unique links remain. The system is highly scalable, allowing for efficient processing of large document volumes, ensuring consistency and compliance across multiple submissions, and significantly improving the efficiency of document preparation workflows.

Furthermore, the disclosed systems and methods present an improvement in automated data processing systems generally, through an advanced and scalable agentic workflow that integrates both machine learning-based analysis and rules-based analysis in a context-sensitive manner. While the specific examples discussed herein provide improvements to the publishing industry, embodiments of the disclosed computing architecture may be utilized in any automated data processing environment, and thus provide an improvement in computing and machine learning technology. That is, unlike even advanced machine learning systems, the embodiments discussed herein provide context-sensitive workflows in which different rules and frameworks may be applied based on input data types and meanings without requiring massive retraining of a machine learning system or compromising through the use of less accurate generalized models.

Implementations of the systems and methods discussed here can be used for several distinct tasks for the electronic publishing industry, First, in some implementations, these systems and methods provide for AI-assisted template identification and section verification. In particular, artificial intelligence is employed to analyze the structure and content of a document in order to automatically identify a template to which the document conforms. The template may be selected from a library of templates, each specifying required sections, headings, and/or navigational elements (e.g., bookmarks and hyperlinks) and corresponding to different document types, semantic types, and/or contexts. Upon identification of the appropriate template, the system may perform an automated comparison of the document's contents with the template's required elements. This enables the system to detect missing sections or improperly formatted elements, thereby ensuring that the document adheres to the correct structure and content requirements. Document completeness may be further enhanced by identifying gaps or omissions based on the template, reducing manual intervention during document preparation.

In another implementation, these systems and methods provide for automated generation of bookmarks, hyperlinks, or other navigational elements within a document, utilizing AI-driven contextual understanding of document content. In some implementations, the system may analyze headings, sections, figures, tables, or other structural components to determine where bookmarks, hyperlinks, or other navigational elements should be inserted. The system is not limited to merely identifying keywords such as “Figure” or “Section,” but can also identify important content for which links are appropriate (e.g. terms that are defined elsewhere, similar elements, related quotes, tables or figures and corresponding descriptions, etc.). The system may generate navigational elements that accurately link to the appropriate content within the document or to external references. Additionally, the system may ensure that generated bookmarks and hyperlinks conform to formatting rules and industry-specific standards (e.g., electronic Common Technical Document (eCTD) requirements for submitting reports to the FDA's Center for Drug Evaluation and Research). This contextual analysis allows the system to automate the navigation process with precision, reducing or eliminating the need for manual bookmark and hyperlink creation.

In some implementations, the system may provide an automated process for generating a runtime Table of Contents (ToC) based on real-time analysis of the document's structure. The system may dynamically extract headings, sections, and/or other relevant document elements to construct a ToC that accurately reflects the content of the document. The generated ToC is then compared against the expected structure as defined by the corresponding identified template, ensuring that all sections and links are present and correctly formatted. This method not only creates a compliant ToC but also verifies the accuracy and completeness of the document's overall structure, thus automatically identifying whether a section is missing or misplaced. The system automatically flags any inconsistencies, missing sections, or errors in the ToC, thereby enabling efficient correction before final submission. In some implementations, the system may also retrieve data corresponding to missing sections from a library for automatic insertion at the identified position (e.g. automatic insertion of relevant boilerplate or similar predetermined data).

In some implementations, the system provides an automated validation mechanism for hyperlinks and bookmarks, ensuring their accuracy, functionality, and compliance with predefined standards. The system performs an exhaustive check to detect broken links, incorrect bookmark destinations, and formatting issues such as non-compliant link properties (e.g., color or magnification settings). In addition, the method includes a novel feature for detecting duplicate and overlapping hyperlinks within the document. The system identifies and resolves these duplications by retaining only the correct and unique hyperlinks, thus preventing navigation errors. The method further includes automated correction capabilities, where identified errors are corrected without the need for manual intervention, ensuring all navigational elements function as intended.

In some implementations, the system may provide efficient scalability, allowing for the automated generation, validation, and quality control of bookmarks and hyperlinks across large volumes of documents. This scalability is crucial for environments where large datasets, such as regulatory submissions, must be processed quickly and accurately. The system ensures consistency in the creation and validation of bookmarks, hyperlinks, and ToCs across multiple documents by conducting comprehensive consistency checks. These checks ensure that the formatting, linking, and navigation elements remain uniform across all documents, even when processing a high volume of submissions. The method's scalability enhances document preparation workflows, ensuring compliance with industry standards while maintaining high throughput and accuracy.

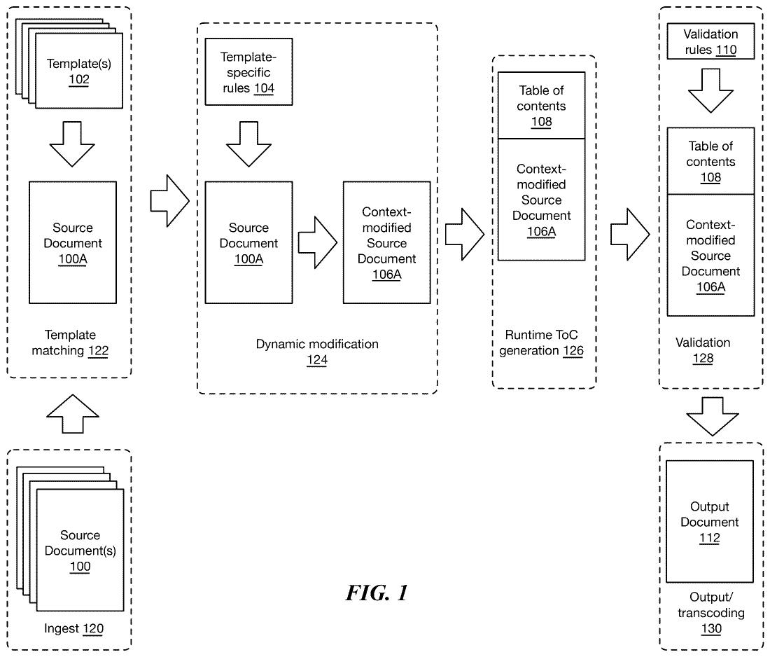

Referring first to FIG. 1, illustrated is a logical diagram of a system for automatic generation and verification of document navigational elements, according to some implementations. As discussed in more detail below, the system may be provided via one or more computing devices, including virtual computing devices executed by one or more physical computing devices. The computing system may ingest 120 one or more source documents 100. In some implementations, ingestion 120 may refer to receiving source documents via upload over a network, retrieving documents via download over a network from another device, receiving documents loaded into the system via a storage medium, retrieving a document drafted or prepared on a storage device of the system, or any other type and form of inputting data for analysis and processing. The source documents 100 may comprise any type and form of document or documents, including text, images or figures, tables, equations, executable code, or any combination of these or other data. The source documents maybe in any suitable format, such as rich text formats, Microsoft Word documents, Portable Document Format (PDF) documents, XML documents, or any other format. In many implementations, a source document 100 may comprise a collection of individual data files. For example, a source document 100 may comprise a text file and one or more image files. Accordingly, a source document 100 may refer to any data file or collection of data files for which navigation elements are to be generated and/or verified.

A source document 100 may have a document type or context, which may be industry specific in many implementations. For example, in the pharmaceutical industry, common document types or contexts include product characteristics (SmPC) documents; product labelling documents; electronic product information (ePI) documents; package leaflet documents; etc. In the financial industry, common document types or contexts may include call reports; audit reports; transaction monitoring reports; etc. In many implementations, document types or contexts may not be identified explicitly. For example, in various implementations, a document may or may not have an explicit identifier, metadata, title, or header that identifies the context or document type.

In some implementations, a first source document 100A may be selected from one or more source documents 100 to be matched 122 to a template from a collection or library of one or more templates 102. Templates 102 may be specific to a document context or type, and may be based on regulatory requirements for such documents. For example, the Structured Product Labeling (SPL) standard defined by the Health Level Seven International (HL7) organization specifies required content and format for prescription drug labels in XML format. The system may include a template 102 specific to the SPL standard, defining what content must be present and where, how it should be formatted, etc. In some implementations, a library may include tens, hundreds, or thousands of templates. In some implementations, a template 102 may comprise boilerplate or predetermined section headings in which data from a document 100 may be inserted.

When a document 100A includes explicit identifiers indicating a document type, the system may extract and/or parse these identifiers via a regular expression (regex) or similar filter. When the document 100A does not include explicit identifiers, the system may parse the document, including text, images, or other data, to identify a matching template 102. In some implementations, text of the document may be provided to a natural language processor (NLP) classifier to parse the text for indicators that it corresponds to a specified template. For example, a document may include a proprietary or non-proprietary drug name, and may also include dosage or adverse reaction information. The classifier may determine that the corresponding document is a product label, and may identify a corresponding template accordingly. In many implementations, such a parser or classifier may comprise a machine learning-based classifier and may be trained in a supervised learning process on training data consisting of documents with identified types or contexts and/or corresponding templates. In some implementations, a classifier may extract semantic identifiers or tokens of text in the document and create a vector in an n-dimensional space corresponding to the identifiers or tokens, with regions in the space corresponding to document contexts or types.

Once a template 102 has been identified, the system may perform dynamic modification 124 of the source document 100A according to template-specific rules 104 to create a modified source document 106A. Dynamic modification may include generating bookmarks, internal links, external links, footnotes, endnotes, anchors, or other such navigation elements. As discussed above, template-specific rules 104 may comprise formatting or navigation element requirements, such as a section order or identification of sections that need to be listed in a table of contents, a depth of a multi-level tree or index to be included, labeling or formatting requirements for bookmarks or links, etc. For example, regulations in some jurisdictions may require a pharmaceutical product label to include warnings before dosages, while in other jurisdictions these may be reversed. The template and corresponding rules may be specific to jurisdictions, such that the document may be properly modified based on the context and type. While described herein as a “modified” document, in many implementations, a copy of the source document may be generated and modified. Accordingly, in many such implementations, modification may refer to creation of a new document with copied content from a source document and added and/or verified navigational elements.

In some implementations, the rules 104 may be stored as executable code or a regex. In other implementations, the rules 104 may be stored as a prompt to be provided with the document to an LLM-based machine learning system or similar instructions. In other implementations, the rules may comprise a mix of explicitly coded rules (which may be variously referred to as explicit rules, static rules, static filters, hard-coded rules, or similar terms) and prompts or instructions (which may be variously referred to as dynamic rules, implicit rules, natural language rules, programmatic rules, or similar terms).

Once the rules are applied, the system may generate 126 a table of contents 108 for the context-modified source document 106A. In some implementations, the table of contents may comprise a listing of all of the bookmarks and hyperlinks or other navigation elements in the document. In other implementations, some navigation elements may not be listed in the table of contents. For example, a table of contents 108 may include bookmarks to section headings or tables, but may not include external hyperlinks. In another example, a table of contents 108 may not include a listing of internal definitions of words, despite these words being linked within the document. In some implementations, a table of contents 108 may have a template-specific format or rules for its generation (e.g. section links first, definitions next, links to external citations next, etc.; or a list of only top level section headings, with subheadings listed at the start of each section). In such implementations, the system may utilize the template 102 and/or template-specific rules 104 to generate the table of contents 108.

In some implementations, the system may apply 128 validation rules 110 to the generated table of contents 108 and context-modified source document. Validation rules 110 may be template-specific, like rules 104, or may be general processing rules applied to all documents, or a combination of these. For example, validation rules 110 may include a regex that identifies hyperlinks in a document to ensure they start with “http://”; a filter to determine whether a hyperlink improperly spans a page break; or a counter to ensure that there's a bookmark for every table included in the document. In some implementations, if the validation detects errors or anomalies, the system may return to dynamic modification 124 and/or table of contents generation 126 to re-generate or modify navigation elements until the document passes validation 128.

In some implementations, the system may output 130 the modified and validated document 112, e.g. to a storage device, another computing device, etc. For example, the source document 100 may have originally been provided to the system via an interface of a web application by another computing device, and the system may provide the modified and validated output document 112 for downloading by the other computing device. In some implementations, outputting the document may include transcoding the document into another format or combining the document with other documents. For example, in some implementations, the system may generate an output PDF of an originally provided Word document. In other implementations, a multi-page source document may be divided up into subparts for processing in parallel by multiple computing devices or processors of the system, and the modified and validated subparts may be recombined by the system as part of the output process 130. This may allow for greater speed of processing, particularly for very large documents.

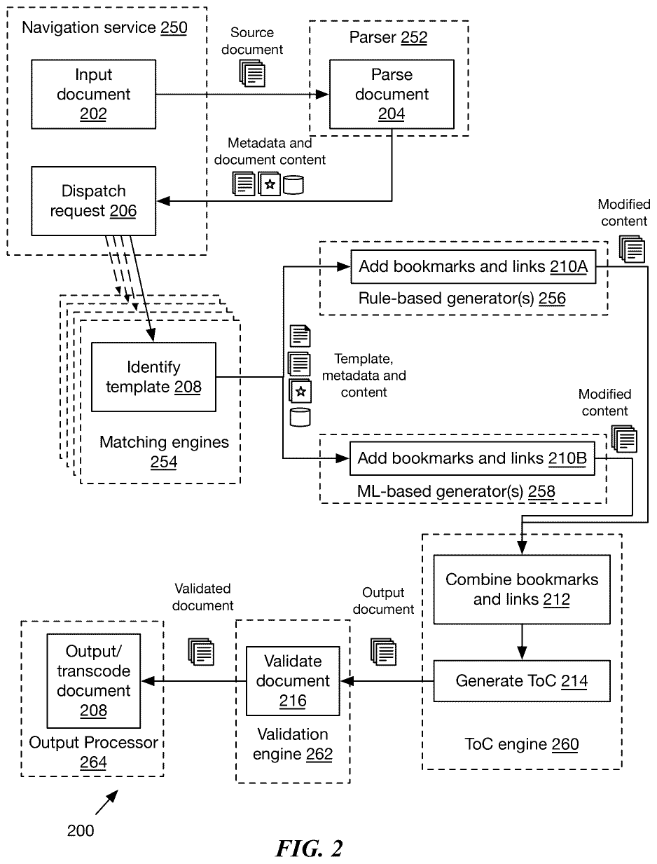

FIG. 2 is an activity diagram of a method 200 for automatic generation and verification of document navigational elements, according to some implementations. A navigation service 250 may be executed by a computing system, such as a web application or software-as-a-service (SaaS) application, local application, server, daemon, routine, or other executable logic. The navigation service 250 may include a user interface, such as a graphical user interface (GUI) or command line interface (CLI), and/or may include an application programming interface (API) for communicating with another application. In some implementations, the navigation service 250 may communicate with another computing device (not illustrated). For example, the navigation service 250 may comprise a user interface of a web application and receive uploaded documents from another computing device.

Navigation service 250 may receive or retrieve a document or documents (referred to generally as a source document or documents) as an input at step 202. As discussed above, a document may comprise any type and form of document or documents, including text, images or figures, tables, equations, executable code, or any combination of these or other data. The source document may be received from another computing device, retrieved from a storage device, or otherwise ingested.

In some implementations, the navigation service 250 may send the source document to a parser 252. Parser 252 may comprise an application, service, server, daemon, or other executable logic for receiving source documents and parsing the documents to identify and extract content and/or metadata at step 204. For example, parser 252 may extract information from a header or other portion of the document, and reformat the information into a standardized format (e.g. as XML or JSON data). Similarly, content from the document may be extracted. For example, in some implementations, parser 252 may receive a document comprising text and images and separate the text and images into separate data files for processing. In other implementations, parser 252 may perform decompression or decryption of compressed or encrypted input documents. In some implementations, parser 252 may transcode input documents. For example, in some implementations, parser 252 may transcode a Word document into a rich text format (RTF) document. In some implementations, parser 252 may perform optical character recognition to extract text within images in the document (e.g. a flattened PDF with images of text). Parser 252 may be executed by the same computing system executing the navigation service 250, or may be executed by another computing system or device. For example, in some implementations, navigation service 250 may be executed by a web server, and parser 252 may be executed by one or more virtual machines of an application service. This may allow for scalability.

In some implementations, parser 252 may provide the extracted metadata and document content to the navigation service 250. At step 206, navigation service 250 may generate one or more requests to matching engines 254 for matching the metadata and document content to a template from a template library. In other implementations, the parser 252 may generate the requests and communicate with matching engine(s) 254 directly.

Matching engine(s) 254 may comprise one or more applications, services, servers, daemons, routines, or other executable logic for identifying a template matching or corresponding to a source document, based on the extracted metadata and document content, Matching engine(s) 254 may be executed by the same computing system as navigation service 250 and/or parser 252, or may be executed by another computing system. For example, matching engine(s) 254 may comprise one or more virtual machines executed by one or more physical computing devices, and instantiated as needed. Matching engine(s) 254 may comprise hardware, software, or any combination of hardware and software. For example, in some implementations, matching engine(s) 254 may comprise an API service for receiving requests and providing matching templates, and a graphics processing unit (GPU) or tensor processing unit (TPU) for executing a machine learning model to classify and match an input document and metadata to a template. For example, a matching engine 254 may comprise a neural network with nodes in an output layer corresponding to templates.

In some implementations, each matching engine 254 may be responsible for comparing a source document, content, and/or metadata to a subset of templates from a template library. For example, a template library with a thousand templates may be divided into ten subsets of one hundred templates, and each of ten matching engines 254 may compare input data to a different template subset. This may both reduce the time taken to identify a template, and also increase accuracy by allowing each matching engine 254 to be separately trained on the specific templates of the subset. For example, each matching engine 254 may be trained in a supervised learning process on training data of documents corresponding to its designated subset of templates (and, in some implementations, documents corresponding to non-matching templates, to help reduce false positive matches). This may also reduce the size of an output layer of a neural network of each matching engine 254, which may reduce complexity and allow for faster training.

In some implementations, input document content and metadata may be compared to all templates in a library. In other implementations, the document content and metadata may be first classified at a high level (e.g. by industry), and then compared to a subset of templates corresponding to the classification (e.g. templates for that specific industry). This may drastically reduce the number of templates to which a document is compared and/or allow for instantiation of fewer matching engines 254. In such implementations, the templates may be organized in a multi-layer hierarchy (e.g. by jurisdiction, industry, sub-industry, etc.; manufacturer, jurisdiction, product line, document type, etc.; or any other such multi-layer hierarchy). Classification may be performed in an iterative process via a sequence of trained machine learning models, with each model corresponding to a different layer in the hierarchy (and or different collection of nodes, such as a first model at a first layer for classifying by industry, a second model at a second layer for classifying documents determined to be related to the pharmaceutical industry, a third model at the second layer for classifying documents determined to be related to a financial industry, a fourth model at a third layer for classifying pharmaceutical industry documents related to product labels, a fifth model at the third layer for classifying pharmaceutical industry documents related to adverse events, etc.). This may increase accuracy and reduce training requirements for each model.

As discussed above, at step 206, navigation service 250 (and/or parser 252) may generate one or more requests to matching engines 254 for matching the metadata and document content to a template from a template library. The navigation service 250 (and/or parser 252) may determine a number of requests to generate dynamically, such as to meet load balancing requirements, and may in some implementations select different subsets of templates to match. For example, metadata of the document may identify a jurisdiction or industry, and the navigation service 250 may generate one or more requests for matching engines 254 to compare document content to templates corresponding to that jurisdiction or industry. The requests may be in any suitable format, such as representational state transfer (RESTful) GET or PUSH requests, API requests, remote procedure calls (RPCs), or any other type of request, and may include the document content and/or metadata in XML or JSON format or any other suitable format as prepared by parser 252.

At step 254, the matching engine or engines 254 may match the metadata and/or document content to one or more templates from a library of predetermined templates (or subsets of predetermined templates). As discussed above, in many implementations, this may be done by processing tokens of the document content and/or metadata via a trained neural network, with nodes in an output layer corresponding to templates and a highest scoring node corresponding to a selected template. In many implementations, a confidence threshold may be applied to the output. For example, where multiple matching engines 254 each compare an source document to different subsets of templates, a first matching engine 254 using a trained model based on a subset of templates including the correct template may identify a match of a source document to the correct template at a very high confidence level, while a second matching 254 using a trained model based on a second subset templates not including the correct template may incorrectly identify a match of the source document to an incorrect template at a lower confidence level. In such implementations, to avoid false positives being received from each matching engine, each engine may disregard matches below a predetermined confidence level. In other implementations, all of the matching engine outputs may be combined, and a highest confidence match from all of the outputs may be selected,

The identified template, metadata, and content may be provided to rule-based generator(s) 256 and ML-based generator(s) 258 to add navigational elements at steps 210A and 210B. Although not illustrated, in some implementations, one or more matching engines 254 may return an identification of a matching template to the navigation service 250 and/or parser 252 for forwarding to rule-based generator(s) 256 and ML-based generator(s) 258 at steps 256 and 258. In other implementations, a matching engine 254 identifying a matching template (or in some implementations, an identification of a template match at a confidence above a threshold) may directly provide a request to rule-based generator(s) 256 and ML-based generator(s) 258.

Rule-based generator(s) 256 may comprise one or more applications, services, servers, daemons, routines, or other executable logic for applying template-specific rules to a source document or content of the document to generate navigational elements at step 210A. For example, in some implementations, rule-based generator(s) 256 may comprise one or more regex rules for execution by a computing system, such as rule to identify a table, image, or section or chapter heading in a document and to generate a bookmark or link corresponding to the location of the table, image, or section or chapter heading. In some implementations, a single generator 256 may be used, while in other implementations, multiple generators 256 may be utilized (e.g. with different filters or rules, or on different portions of a large document).

ML-based generator(s) 258 may comprise one or more applications, services, servers, daemons, routines, or other executable logic for using a machine learning model on a source document or content of the document to generate navigational elements at step 210B. For example, in some implementations, rule-based generator(s) 258 may comprise one or more machine learning models to generate bookmarks or links based on text or images in the document. In some implementations, a single generator 258 may be used, while in other implementations, multiple generators 258 may be utilized (e.g. on different portions of a large document, or with different types of tokens or other inputs). The models used may be template-specific and may be trained via supervised learning from a data set of documents corresponding to the identified template that include navigational elements. For example, the models may be trained to identify words with explicit definitions elsewhere in the text, proprietary and non-proprietary drug names, or other contextually relevant navigational links (e.g. a communication standard that discusses receiving and analyzing input data packets in one section may include a link to a packet format specification in another section, or error codes for flawed packets in still another section). When then applied to documents or contents corresponding to the template lacking navigational links, the model may automatically insert links or tokens corresponding to links based on their likelihood of appearance at a particular location,

The modified documents output by generators 256, 258 may be provided a ToC engine 260. ToC engine 260 may comprise an application, service, server, daemon, routine, or other executable logic for aggregation of the modified documents and generation of a combined table of contents. In some implementations, ToC engine 260 may be part of a navigation service 250 (e.g. a subroutine or workflow). At step 212, the ToC engine 260 may combine or merge the outputs from the generators. This combining or merging may include deduplication of any navigational elements that are common to the outputs (e.g. if both a rule-based generator 256 and ML-based generator 258 place a bookmark at the same location in the contents). At step 214, the ToC engine 260 may generate a table of contents using the bookmarks and other navigational links generated by the generators 256, 258. The table of contents may be generated according to template-specific rules. For example, in many templates, the table of contents may list some but not all bookmarks or links, such as a list of section or subsection headings, tables, or figures, but not links to external data sources or internal definitions. In other templates, these requirements may differ. Further requirements may include depth of a hierarchy to be listed (e.g. sections, subsections, sub-subsections, etc.), as well as formatting, font or style, whether the table of contents should be placed at the front or at the end as an index, etc.

The output document, including the table of contents, may be provided to a validation engine 262. Validation engine 262 may comprise an application, server, service, daemon, routine, or other executable logic for verifying at step 216 that a document, navigational elements, and table of contents comply with template-specific rules or requirements. Validation engine 262 may be part of the ToC engine 260 and/or the navigation service 250 in many implementations. In many implementations, validation engine 262 may comprise one or more regex filters or other programmatic rules. For example, in some implementations, validation engine 262 may verify that the table of contents includes every required bookmark according to a set of predetermined rules (e.g. rules for submission to a regulatory agency), as well as verifying other properties such as whether links cross page breaks, whether external links work without returning errors, etc. If the document does not pass validation, in some implementations, the validation engine 262 may provide the document to the rule-based generators 256 and/or ML-based generators 258 for further modification and correction. In some implementations, the validation engine 262 may generate a request for a reidentification of the document template at step 208 along with an indication that the previously selected template was inaccurate.

Once validated, the document may be provided to an output processor 264. Output processor 264 may comprise an application, service, server, daemon, routine, or other executable logic for preparing and delivering the validated document to a destination at step 208. In some implementations, output processor 264 may be part of the validation engine 262 and/or the navigation service 250. For example, in some implementations in which the navigation service 250 provides an interface to a SaaS application and receives a document for processing from another computing device, the navigation service 250 may provide the validated document to the other computing device for download. Preparing the document for delivery may comprise compressing the document, encrypting the document, and/or transcoding or translating the document (e.g. into another format and/or another language via a machine translation). For example, in some implementations, the output processor 264 may generate a PDF of the document for storage or delivery.

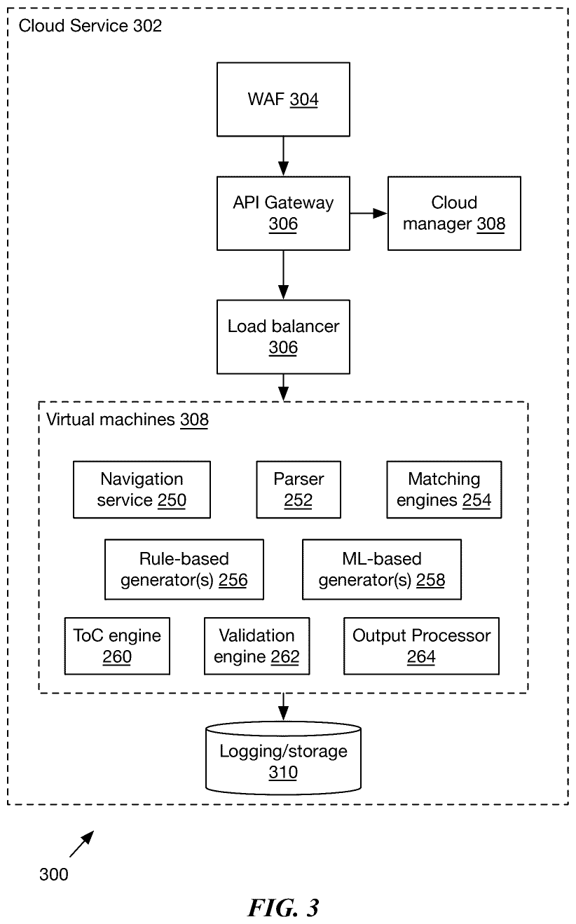

FIG. 3 is a block diagram of a scalable computing system 300 for automatic generation and verification of document navigational elements, according to some implementations. In some implementations, the system may be provided by a cloud service 302, which may comprise one or more virtual machines executed by one or more physical machines (e.g. a server farm, cluster, etc.), and may be referred to variously as an application service, web service, SaaS provider, compute cloud, or by similar terms.

Cloud service 302 may comprise a web application firewall or WAF 304, which may provide a secure gateway or service for access by external computing devices. For example, in some implementations, WAF 304 may comprise the Amazon Web Services WAF provided by Amazon, Inc. WAF 304 may provide access to an API gateway 306 for authentication and processing of requests from external computing devices. A cloud manager 308, which may comprise an application, service, server, or other executable logic for authenticating and controlling access and processing requests, may receive requests and/or documents for analysis and processing from external devices via gateway 306. The cloud manager 308 may generate requests to one or more virtual machines 308 via API gateway 306. Virtual machines 308 may be instantiated under control of an elastic load balancer 306 as needed. Virtual machines 308 may provide various components of the system, including navigation service 250, parser 252, machine engines 254, rule-based generators 256, ML-based generators 258, ToC engine 260, validation engine 262, and output processor 264. The virtual machines 308 may be part of a virtual private cloud, with access restricted via the API gateway 306 and WAF 304. For example, in some implementations, one or more components of system 300 may be provided by AWS Lambda serverless compute service or the AWS Fargate serverless compute engine, both provided by Amazon, Inc. Virtual machines 308 may process documents and provide documents with generated navigational elements as discussed above. In some implementations, documents and/or logging information may be stored to storage 310. This may be used for error logging and/or retraining or improving machine learning models.

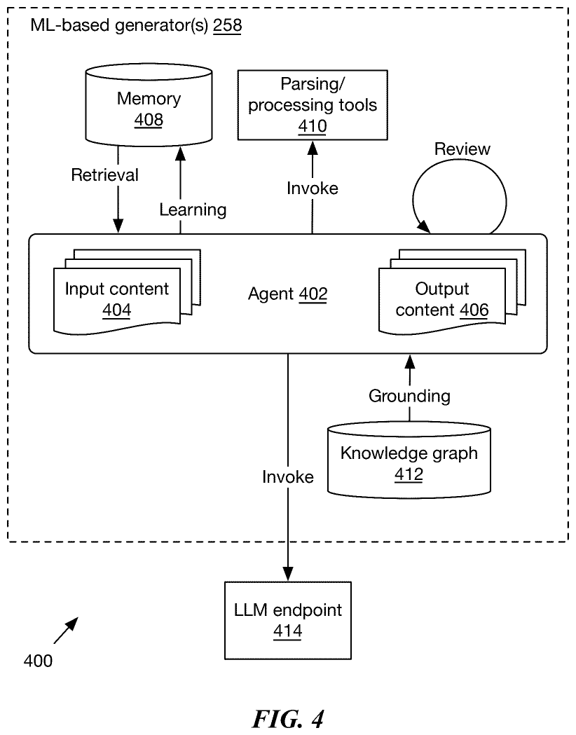

In many implementations, workflows of the system (e.g. matching engines, generators, ToC or validation engine, etc.) may be provided as cognitive agents, sometimes referred to as intelligent agents or computational agents. Cognitive agents may comprise applications or models executed by general and/or specialized processors, including CPUs, GPUs, or TPUs for performing various analysis and processing tasks. FIG. 4 is a block diagram of an example cognitive agent 400 used for ML-based generator(s) 258, according to some implementations. Cognitive agents used for other workflows may be similar.

Cognitive agent 400 may comprise a processing agent 402, sometimes referred to as the cognitive agent itself, an intelligent agent, an agent, or similar terms. Agent 402 may comprise a machine learning algorithm, such as a neural network, for processing input content or data 404 and generating output content or data 406. Accordingly, agent 402 may comprise an application, service, server, daemon, routine, or other executable logic for executing a machine learning model and/or other functionality. Agent 402 may comprise hardware such as a GPU or TPU, software, or a combination of hardware and software. Agent 402 may communicate with other applications and/or computing devices via any suitable method, such as via API or RPC calls, RESTful requests, etc.

The agent 402 may access a memory store 408, which may comprise working memory, sometimes referred to as short term memory or intra-session memory, and/or episodic memory, sometimes referred to long term memory or intra-session memory. Memory 408 may allow for storage of parameters during or between sessions, such as data to add to input content for processing (e.g. previous input content or previously generated output content). Accordingly, via memory 408, the agent 402 may be able to learn and retrieve knowledge of a current context and past query-response pairs.

Agent 402 may also invoke one or more parsing and/or processing tools 410. Though shown as part of generator 258, in many implementations, the tools 410 may be provided via other applications or services, such as other agents 402. For example, via an API, agent 402 may transmit a request to retrieve a template from a library for processing content. Other tools may include applications or services for code generation, web searching, image analysis, optical character recognition, etc. The agent may analyze input content (e.g. via keyword or semantic search) to identify corresponding tools and/or parameters to include in a request to a tool.

Agent 402 may access a knowledge graph 412 stored in memory of the computing device or another computing device. Knowledge graph 412 may comprise a linked graph with nodes corresponding to semantic entities (e.g. terms, phrases, document types, domains, jurisdictions, manufacturers, or other similar entities) and links between nodes denoting relationships between entities. For example, a knowledge graph 412 may include links between nodes corresponding to proprietary names and non-proprietary names for pharmaceuticals, allowing an agent to identify their equivalence when parsing or analyzing a document.

In some implementations, agent 402 may communicate with an LLM endpoint 414 to invoke or request responses given a prompt. The prompt may be generated based on input content, past prompts and responses retrieved from memory 408, data provided by processing tools, and/or correlations or relationships identified via knowledge graph 412. The communications may be via any suitable interface with the LLM endpoint, such as API or RPC calls or other requests. In some implementations, the LLM endpoint 414 may be another cognitive agent 400.

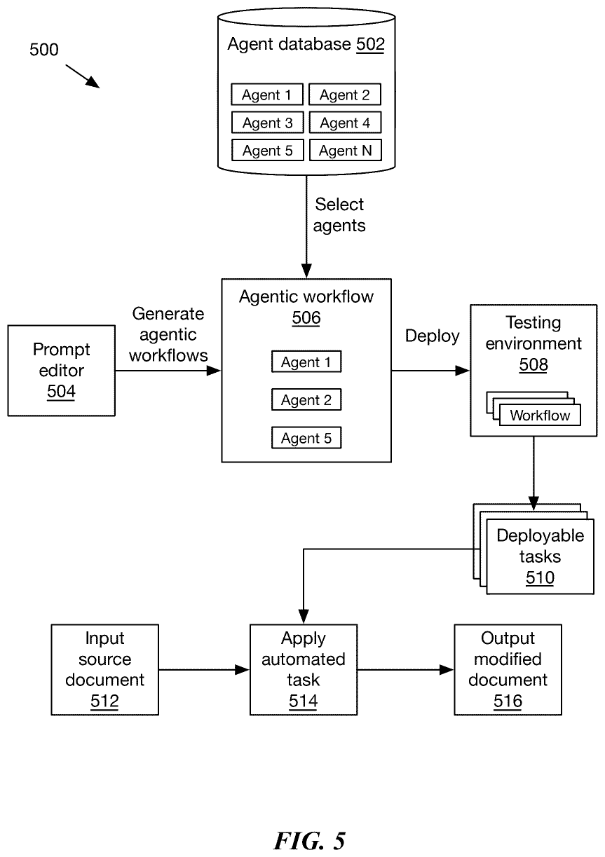

In some implementations, creating workflows from cognitive agents may be automated via a code generation system, such an LLM-based code generator. This may allow for higher customization and specialization of template-specific agents. FIG. 5 is a functional diagram of a compute framework 500 for automatic generation and verification of document navigational elements, according to some implementations. An agent database 502 may store a variety of cognitive agents created by developers with various functionality or models. For example, agents may have an architecture and components as described in connection with cognitive agent 400 in FIG. 4, and utilize different knowledge graphs (e.g. specialized knowledge graphs for different document contexts or types) and memories (e.g. different inter- and intra-session memories of requests and responses). The agents may be stored in database 502 in any suitable format, such as a collection of data files, an indexed database, or any other type and form of storage.

Workflows 506 may be created via a prompt editor 504 to specify particular tasks, such as identifying images or tables in a document and generating bookmarks, identifying and verifying external links in a document, etc. An appropriate agent or agents for a workflow may be selected based on their metadata, structure, knowledge graph, and/or memory corresponding to keywords in the prompt, and a workflow 506 may be generated. The workflow may incorporate multiple agents in a processing flow or pipeline (e.g. providing outputs from one agent as inputs to another). In some implementations, workflows may be deployed in a testing environment 508 and the workflow prompts edited for optimization or to correct errors in the generated output. Once finalized, the workflow may be deployed as a task 510 for use on production data. Users may provide input source documents 512 and the system may select and execute a corresponding workflow task 510 to generate and output a modified document 516.

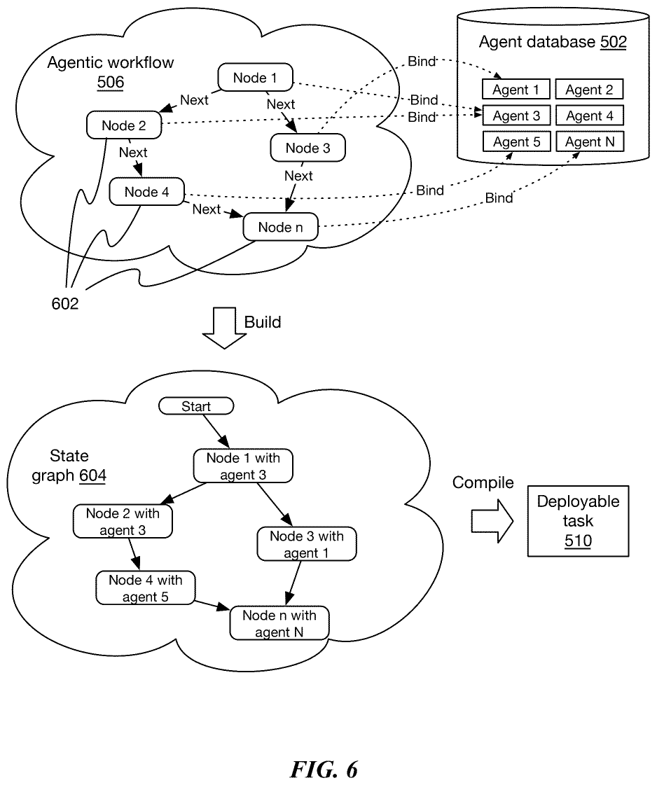

FIG. 6 is a diagram of an example of generation of an agentic workflow for data processing, according to some implementations. The workflow generation may be performed based on a prompt provided by a prompt editor 504, as discussed above. The workflow 506 may be conceptualized as a directed graph with nodes 602 corresponding to subtasks or steps within the workflow to be performed by agents, with agents providing outputs to subsequent agents in the flow until arriving at an output of the workflow. As shown, there may be multiple paths through the graph, based on an output of an earlier node. For example, node 1 may represent a processing task in which different outcomes are possible (e.g. detecting whether or not a table is present in a document) and based on the outcome, different subsequent nodes may be activated (for example, node 2 to generate a bookmark if a table is detected, and node 3 to identify if an external table is referenced if no table is detected). In some implementations, the graph may include loops or edges that return to earlier nodes (e.g. for iterative processes).

In many implementations, it may not be appropriate for one agent to perform every subtask in the workflow. For example, different agents may have different training, knowledge graphs, or memories that are useful for different subtasks. During the building process, an appropriate agent may be identified for each node and bound to the corresponding node, as shown in state graph 604. The graph may then be compiled into a deployable task 510, which may then be invoked to asynchronously instantiate agents according to the data flow and decision branches.

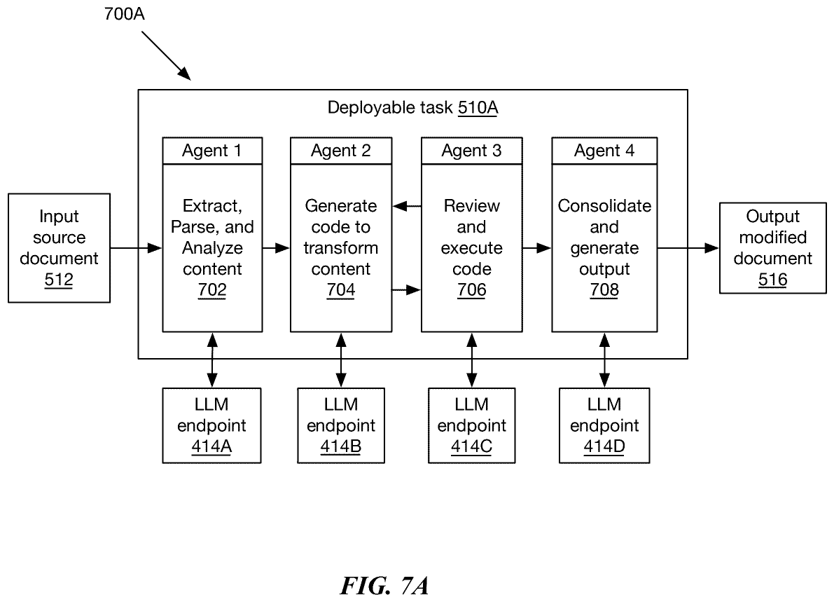

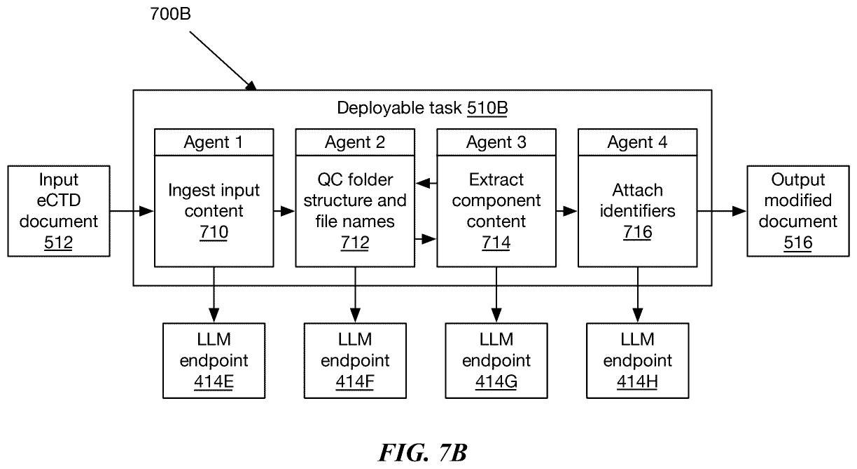

FIGS. 7A and 7B are data flow diagrams of examples of agentic workflows for automatic generation and verification of document navigational elements, according to some implementations. The example workflows are for illustration purposes only, and many other workflows may be utilized, including workflows with a greater or smaller number of subtasks and additional branches or pathways.

Referring first to FIG. 7A and workflow 700A, an input source document 512 may be received for processing, and a computer system may execute a deployable task 510A. As part of the deployable task 510A, at step 702, a first agent 1 may be instantiated to extract, parse, and analyze content of the source document. As part of this subtask, the agent may extract content of the source document and generate a prompt for an LLM 414A based on the extracted content, a knowledge graph of the agent, and any relevant queries/responses in memory of the agent. For example, the prompt may direct the LLM to classify the input content to identify a corresponding template, as discussed above. Once generated, the prompt may be provided via an API to LLM 414A, which may process the input data and provide an output. For example, the output may include the input content and an identification of the corresponding template.

The output may be passed to agent 2 for generating code to transform the input content at step 704. Agent 2 may be selected based on the identified template and/or may access a knowledge graph and memory corresponding to the identified template and may generate a prompt to an LLM 414B to create code to modify the input content to include navigational elements. For example, the prompt may direct the LLM to dynamically create a regex based on the input content and template-specific rules and semantic associations. The prompt may be provided via an API to LLM 414B, which may generate code in a suitable format (e.g. python, Go, Java, etc.).

The returned code may be provided to agent 3 for review and execution at step 706. Agent 3 may be specialized for parsing and verifying code syntax (e. g, confirming code structure, checking that conditionals and parameters are properly formatted, etc.). In some implementations in which there are errors, agent 3 may provide an identification of errors to agent 2, which may modify the prompt and generate new code via LLM 414B. Once the code is verified, in some implementations, agent 3 may provide the code for execution by an LLM 414C or, in some implementations, by another agent or processor. In some implementations, steps 704-706 may be repeated for additional sections or elements (e.g. generation of a table of contents or index).

The processed document, with navigation elements added, may be provided to agent 4 for consolidation and generation of an output document at step 708. As discussed above, in some implementations, the document may be transcoded, compressed, encrypted, or otherwise processed to generate an output document 516. In some implementations, the document may be provided to an LLM 414D for consolidation (e.g. combining multiple sections, or combining text, images, tables, etc. into a single document according to a template-specific rule set). The output document 516 may be provided to a requesting computing device, stored in memory, or otherwise output.

Referring now to FIG. 7B, and workflow 700B, input source documents 512, such as documents and files of an electronic common technical document (eCTD) dossier or package, may be received for processing, and a computer system may execute a deployable task 510B. As part of the deployable task 510B, at step 710, a first agent 1 may be instantiated to ingest content of the dossier. As part of this subtask, the agent may extract content of the dossier, including individual data files of the dossier, and generate a prompt for an LLM 414E based on the extracted content, a knowledge graph of the agent, and any relevant queries/responses in memory of the agent. For example, the prompt may direct the LLM to classify the dossier to identify a template for eCTD documents, as discussed above. Once generated, the prompt may be provided via an API to LLM 414E, which may process the input data and provide an output. For example, the output may include the input content and an identification of the template.

The output may be passed to agent 2 for checking that folder structures and file names of the eCTD dossier are in compliance with regulatory requirements at step 712. Agent 2 may be selected based on the identified template and/or may access a knowledge graph and memory corresponding to the eCTD dossier template and may generate an API request to an LLM 414F to verify the folder structure and file names.

Once verified, the dossier may be provided to agent 3 for extraction of data from individual components of the dossier at step 714. Agent 3 may be specialized with template-specific rules for extracting and collating content according to the file structure of the dossier. In some implementations, steps 712-714 may be repeated iteratively for additional subfolders of the dossier.

The extracted components may be provided to agent 4 to have labels or identifiers added at step 716. The labels may be added according to a ruleset or knowledge graph specialized for use with eCTD documents, as discussed above. The labeled components may be output for storage or further processing (e.g. as individual documents for transformation or addition of navigation elements, as in workflow 700A).

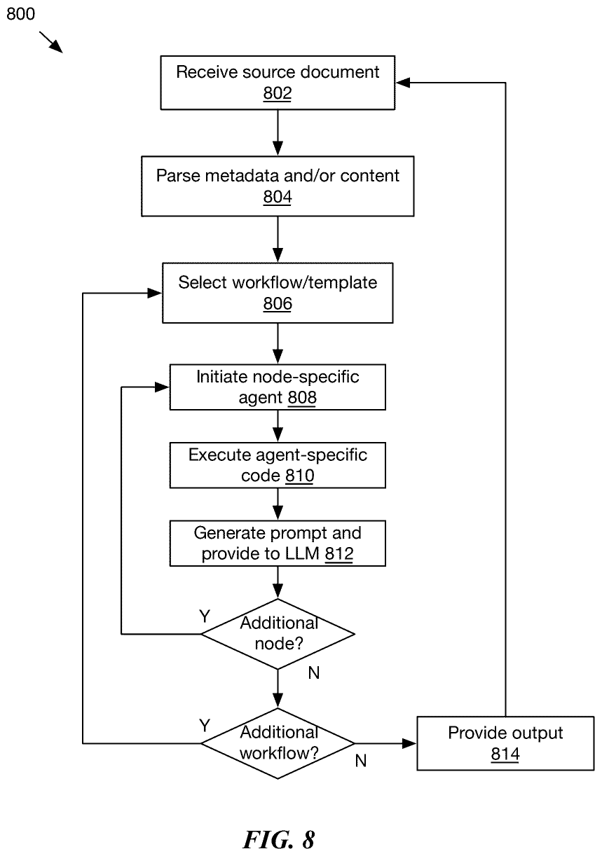

FIG. 8 is a flow chart of a method 800 for automatic generation and verification of document navigational elements, according to some implementations. At step 802, a computing system, such as any of the computing systems discussed herein and comprising one or more computing devices, may receive a source document or documents (e.g. a dossier, collection, or other group of documents). The source document may be in any suitable format and may comprise text, images, tables, graphs, charts, equations, or other data. In some implementations, the computing system may receive the document or documents from another computing device or devices. For example, in some implementations, the computing system may provide an interface to a SaaS application or web service, and another computing device may transfer or upload the document or documents for processing via a network, such as the Internet or a local network.

At step 804, in some implementations, the computing system may parse the document or documents for metadata and/or content to determine a document type or context. In some implementations, parsing the document or documents may comprise executing a rules-based filter such as a regex or similar filter to identify keywords or other predetermined features (e.g. document type tags in metadata, keywords in a title or abstract, section or subsection headings matching predetermined keywords, etc.). In some implementations, parsing the document or documents may comprise providing the document or documents, or a portion of the document or documents, to one or more trained machine learning models (e.g. an LLM) trained to identify and extract keywords or generate identifiers of a document type or context. For example, a model may be trained to identify a context based on keywords or phrases related to an industry, such as a pharmaceutical industry, legal industry, or financial industry. In some implementations, parsing the document or documents may comprise transmitting a request, by the computing system, to another computing system or component of the computing system or another system (e.g. to a parser executed by the computing system or another computing system). The component or parser may comprise an agentic workflow for extracting and parsing semantic context of the document or documents.

At step 806, in some implementations, using the metadata and/or content or extracted or generated identifiers of the semantic context, the computing system may select a workflow and/or template based on the context or document type. In some implementations, selecting the workflow and/or template may comprise matching the metadata or contextual information to metadata and/or contextual information associated with a template or set of predetermined rules, knowledge graphs, or other data about the context or document type (e.g. formatting requirements, navigational element requirements, etc.). In some implementations, selecting the workflow and/or template may comprise providing the metadata and/or content or extracted or generated identifiers of semantic context to one or more matching engines or agents or other machine learning-based classifiers. As discussed above, in some implementations, different matching engines or classifiers may attempt to match the metadata or context to different subsets of templates from a template library. The computing system may provide a plurality of requests for identifying a matching template to a corresponding plurality of matching engines or classifiers, each responsible for a different subset of templates. As discussed above, in some implementations, matching may be performed as an iterative process through a multi-level hierarchy, such as determining a relevant industry or jurisdiction, and then matching to a subset of templates specific to that industry or jurisdiction. This may reduce the number of matches needed to be performed by eliminating irrelevant templates early in the process.

At step 806, in some implementations, the computing system may select a template and/or template-specific workflow based on the identified match. As discussed above, in some implementations, the computing system may provide the document or documents, metadata, context, and/or an identification of a template to one or more generators, cognitive agents, or machine-learning systems, including rules-based generators, machine-learning based generators, or agentic workflows for processing. The processing may include checking and verifying syntax, formatting, or other features of navigation elements; adding navigation elements; generating a table of contents; or other such functions based on the workflow.

At step 808, in some implementations, a node-specific agent may be initiated to process the document or documents or other data. As discussed above, in many implementations, a workflow may comprise multiple nodes, each associated with a subtask and agent. The document or documents or other data (e.g., portions of the document or documents, template identifiers, context information, etc.) may be provided to the agent in a request or an agent may be instantiated to execute the subtask. In many implementations, the agent may be provided by another computing device, and accordingly at step 808, the computing system may transmit a request to the other computing device to initiate the agent and execute the subtask or workflow.

At step 810, the initiated agent (and/or the computing system or another computing system) may execute agent-specific code or functions, as discussed above. This may include pre-processing or parsing data, identifying correlations in a knowledge graph, retrieving past query/response pairs, etc. At step 812, the initiated agent (and/or the computing system or other computing system) may generate and provide one or more prompts to an LLM or other machine-learning system, execute a trained model to generate a response or receive a response from the LLM, and/or process or verify the response.

As discussed above, in some implementations, a workflow may comprise multiple subtasks. In such implementations, steps 808-812 may be repeated for each further subtask. Similarly, in some implementations, processing a document may comprise multiple workflows, In such implementations, steps 806-812 may be repeated for additional workflows.

At step 814, an output may be generated. In some implementations, generating the output may comprise collating or aggregating outputs from multiple agents or workflows. In some implementations, generating the output may comprise compressing, encrypting, transcoding, or otherwise processing a document or documents to generate a finalized output. In some implementations, one or more template-specific rules may be applied to an output document or documents to verify compliance with template requirements for formatting, syntax, section inclusion, structure, etc.

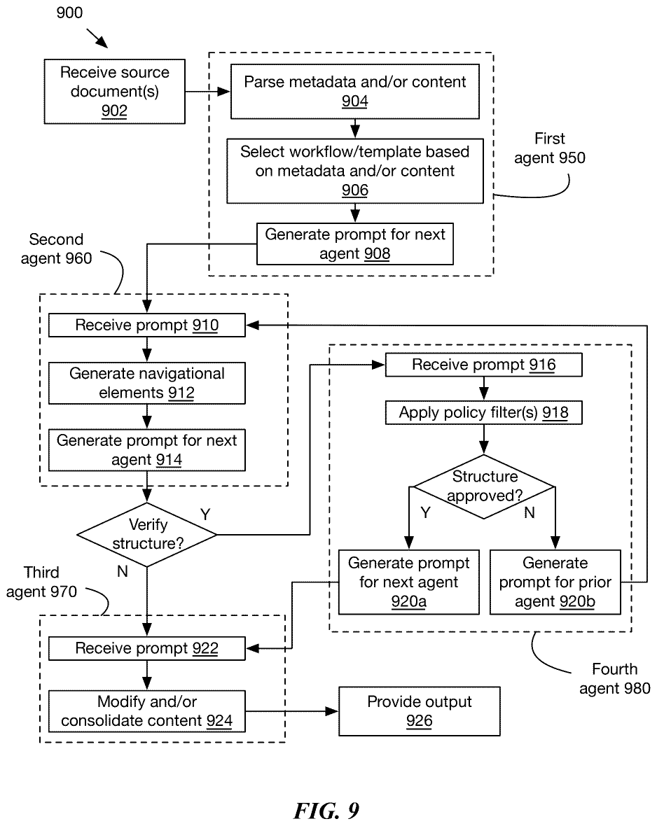

FIG. 9 illustrates a non-limiting example implementation of method 800, referred to as method 900 for automatic generation and verification of document navigational elements. At step 902, a computing system, such as any of the computing systems discussed herein and comprising one or more computing devices, may receive a source document or documents (e.g. a dossier, collection, or other group of documents). The source document or documents may be in any suitable format and may comprise text, images, tables, graphs, charts, equations, or other data. In some implementations, the computing system may receive the document or documents from another computing device or devices. For example, in some implementations, the computing system may provide an interface to a SaaS application or web service, and another computing device may transfer or upload the document or documents for processing via a network, such as the Internet or a local network. Accordingly, various components of method 900 (or method 800) may be performed by different computing systems or devices in communication with each other.

At step 904, in some implementations, the computing system may parse the document or documents for metadata and/or content to determine a document type or context. In some implementations, parsing the document or documents may comprise executing or instantiating an first agent 950 of an agentic workflow for extracting and parsing semantic context of the document or documents. In some implementations, the first agent 950 may comprise a trained machine learning model (e.g. an LLM) trained to identify and extract keywords or generate identifiers of a document type or context. In some implementations, the first agent 950 may comprise a rules-based filter such as a regex or similar filter to identify keywords or other predetermined features (e.g. document type tags in metadata, keywords in a title or abstract, section or subsection headings matching predetermined keywords, etc.). In various implementations, the first agent 950 may comprise a combination of these or other models or filters.

At step 906, in some implementations, using the metadata and/or content or extracted or generated identifiers of the semantic context, the computing system and/or first agent 950 may select a workflow and/or template based on the context or document type. In some implementations, selecting the workflow and/or template may comprise matching the metadata or contextual information to metadata and/or contextual information associated with a template or set of predetermined rules, knowledge graphs, or other data about the context or document type (e.g. formatting requirements, navigational element requirements, etc.). In some implementations, selecting the workflow and/or template may comprise providing the metadata and/or content or extracted or generated identifiers of semantic context to one or more matching engines or agents or other machine learning-based classifiers. As discussed above, in some implementations, different matching engines or classifiers may attempt to match the metadata or context to different subsets of templates from a template library. The computing system may provide a plurality of requests for identifying a matching template to a corresponding plurality of matching engines or classifiers, each responsible for a different subset of templates. As discussed above, in some implementations, matching may be performed as an iterative process through a multi-level hierarchy, such as determining a relevant industry or jurisdiction, and then matching to a subset of templates specific to that industry or jurisdiction.

At step 908, in some implementations, the first agent 950 and/or computing system may generate a prompt for a subsequent agent (e.g. second agent 960). The prompt may comprise content of the source document(s) and/or metadata of the source document(s), and may be generated according to a rule corresponding to the selected workflow or template. For example, depending on the selected workflow, different prompts may be generated according to templates corresponding to each workflow.

In many implementations, other agents (e.g. second agent 960, third agent 970, and/or fourth agent 980) may be selected and/or instantiated or executed based on the selected workflow. Such instantiation or execution may be performed after selection of the workflow at step 906; as a result, memory and processing utilization for these additional agents beyond the first agent 950 may be delayed until subsequently needed, reducing the system requirements during execution of steps 904-908. This may increase scalability and efficiency of the system. Additionally, as discussed above, because different agents may be utilized in different workflows, agents not needed for a particular selected workflow may not be instantiated or executed in some implementations. In a system that may potentially have dozens, hundreds, or thousands of agents for different workflows, this may drastically reduce memory and processing resources needed by the computing system, without sacrificing functionality or flexibility. Furthermore, each agent may be specialized for its corresponding workflow(s), allowing for lighter models (e.g. with reduced processing requirements during runtime, and/or reduced training requirements, such as being trained on smaller datasets than other models, trained less frequently than other models, etc.).

At step 910, in some implementations, a second agent 960 (which may be newly instantiated or executed, as discussed above) may receive the generated prompt. In some implementations, the second agent 960 may comprise a trained machine learning model (e.g. an LLM) trained to generate navigational elements based on metadata and/or content of the source document(s) according to a prompt provided by the first agent 950. The second agent 960 may comprise a combination of machine learning models in some implementations, such as a first model to identify document subsections, and a second model to generate a navigational element for each subsection according to a prompt generated by the first model. The second agent 960 may receive the prompt via an internal communication or external communication from another computing system, such as an API, remote procedure call, RESTful request or prompt, a memory structure shared with the first agent 960 (e.g. a shared region of memory and corresponding read ready flag set by the first agent and reset after reading by the second agent), or any other type and form of data exchange.

At step 912, in some implementations, the second agent 960 may generate one or more navigational elements according to the prompt received from the first agent 960 and the source document content and/or metadata. Generating the navigational elements may comprise generating bookmarks, internal or external hyperlinks, anchors, tags, outline level indicators, or other such structural elements. Navigational elements may be in any suitable format, such as HTML or XML data, predetermined data strings or flags, syntax elements, or other such data.

At step 914, in some implementations, the second agent 960 may generate a prompt for a subsequent agent (e. g, a third agent 970 or fourth agent 980). In some implementations, navigational elements may be verified prior to modifying the content, for example to determine if they conform to a predetermined standard or regulatory requirements, or another predetermined format or structure, etc. In such implementations, the second agent 960 may generate a prompt for a fourth agent 980, which may perform steps 916-920 discussed below to verify the navigational elements correspond to the standard or structure. In other implementations (including some implementations in which navigational elements have previously been verified by a fourth agent 980), the second agent may generate the prompt for the third agent 970 to modify the content of the source documents with the navigational elements and/or to consolidate the source documents. The terms third and fourth are thus used to distinguish between the agents, rather than to imply an order of operations. Similarly, other steps of method 900 (or method 800) may be performed in different orders (including executing in parallel in some implementations, such as processing and verifying structure of different documents in a collection of documents by a corresponding plurality of agents).

In implementations in which a fourth agent 980 is used to verify the structure or format of navigational elements and/or documents, at step 916, the fourth agent 980 may receive the generated prompt from the second agent 960. The prompt may comprise the generated navigational elements, document content, and/or document metadata. In some implementations, the prompt may be generated according to a template based on the selected workflow or template (e.g. such as a prompt based on a standard corresponding to the selected workflow with standard-specific requirements). The fourth agent 980 may receive the prompt via an internal communication or external communication from another computing system, such as an API, remote procedure call, RESTful request or prompt, a memory structure shared with the second agent 960, or any other type and form of data exchange.

At step 918, the fourth agent may apply one or more policies or process the received navigational elements and/or document content according to the prompt. In some implementations, the fourth agent 980 may comprise a RegEx or similar filter or combination of filters, a trained machine learning model (e.g. an LLM) trained to verify navigational element or document structure, or a combination of such models or filters. In some implementations, the fourth agent 980 may comprise a search engine or data retrieval engine. For example, in some such implementations, the fourth agent 980 may test all generated external hyperlinks to verify that they correspond to valid addresses and/or include corresponding or relevant data. In some implementations, the fourth agent 980 may retrieve data from an address corresponding to a hyperlink and compare the retrieved data to corresponding document content (e.g. using a semantic cluster analysis or similar natural language processing to determine if the retrieved data and document content are semantically related). This may help ensure that external hyperlinks are both valid and relevant.

If the document and/or navigational elements meet the policy or filter requirements (e.g. valid and relevant links, working bookmarks, navigational structures properly scoped in depth according to a standard or regulatory requirement, etc.), then at step 920a, in some implementations, the fourth agent 980 may generate a prompt for a third agent 970 to modify the content to include the navigational elements and/or consolidate the documents. If not, in some implementations at step 920b, the fourth agent 980 may generate a prompt for the second agent 960 to modify or regenerate the navigational elements in a repetition of steps 910-914. For example, in some implementations, the fourth agent 980 may receive the prompt generated by the first agent 950 at step 908 and used by the second agent at step 912 and may modify the prompt to regenerate the navigational elements to avoid errors, broken links or bookmarks, limit navigational depth, etc. In some other implementations, the fourth agent 980 may generate a prompt to be added to or concatenated with the prompt generated at step 908. The prompt may be provided to the second agent 960 for a further iteration of steps 910-914. In some implementations, steps 910-920b may be repeated until the structure and/or navigational elements are approved or match the corresponding workflow policies.

At step 922, the third agent 970 may receive the prompt (e.g. from the second agent 960 after step 914, or from the fourth agent 980 after step 920a). The prompt may comprise the generated (and potentially approved) navigational elements, document content, and/or document metadata. The third agent 970 may receive the prompt via an internal communication or external communication from another computing system, such as an API, remote procedure call, RESTful request or prompt, a memory structure shared with the second agent 960 or fourth agent 980, or any other type and form of data exchange. The third agent 970 may comprise a RegEx or similar filter or combination of filters, a trained machine learning model (e.g. an LLM) trained to verify navigational element or document structure, or a combination of such models or filters. In some implementations, the prompt may direct the third agent 970 to modify the source document(s) with the generated navigational elements (e.g. to insert navigational links and/or anchors, bookmarks, modify headings or subheadings, generate an index or indexes, generate a table of contents, etc.).

Although shown receiving data from the second agent 960 and/or fourth agent 980, in some implementations, the third agent 970 may retrieve or receive the source document(s) directly from the input (e.g. at step 902) or from a data structure or memory storing the source document(s). This may reduce the amount of inter-agent communication required, and particularly may avoid duplicative transmissions of data (e.g. with the same document content separately provided to the second agent, third agent, and fourth agent). Similarly, in some implementations, the second and/or fourth agents may receive or retrieve the source document(s) directly.

At step 924, in some implementations, the third agent 970 may modify the document content to include the generated navigational elements (and/or move or delete existing navigational elements, in some implementations). In some implementations, the third agent 970 may consolidate several documents into a single document (e.g. concatenating the documents or portions of the documents). For example, in some implementations, the third agent 970 may combine multiple documents as chapters or sections into a single document, and may add section headers, indexes or tables of contents, or other navigational elements or structures.

At step 926, in some implementations, the system may provide the output documents or consolidated document, such as to a requesting client device or system. The documents may be stored in a local or remote memory, transmitted via a network, or otherwise provided as output data. In some implementations, generating the output may comprise compressing, encrypting, transcoding, or otherwise processing a document or documents to generate a finalized output. In some implementations, one or more template-specific rules may be applied to an output document or documents to verify compliance with template requirements for formatting, syntax, section inclusion, structure, etc.

Accordingly, implementations of the systems and methods discussed herein provide a scalable, efficient, AI-assisted method for automating the generation, validation, and quality control of bookmarks, hyperlinks, or other navigational elements in complex documents or collections of documents. Using artificial intelligence, an appropriate document template may be identified, navigational elements may be generated and inserted into the documents or collections of documents, and compliance verification may be performed. The system can thus ensure completeness, accuracy, and adherence to regulatory or industry standards, minimizing or eliminating the need for manual intervention, In some aspects, the present disclosure is directed to a method for automatic generation of navigational elements. The method includes receiving, by a computing system from a computing device, one or more documents for generation of navigational elements. The method also includes selecting, by the computing system, a corresponding template for the one or more documents from a plurality of predetermined templates based on a metadata or a semantic context of the one or more documents. The method also includes generating, by the computing system via a trained machine learning model, one or more navigation elements for the one or more documents based on the selected template. The method also includes modifying, by the computing system, the one or more documents to include the generated one or more navigation elements. The method also includes providing, by the computing system to the computing device, the modified one or more documents.

In some implementations, the method includes comprising instantiating, by the computing system, a plurality of agents according to the selected template, wherein a first agent is configured to generate the one or more navigation elements, and a second agent is configured to modify the one or more documents to include the one or more navigation elements.

In some implementations, selection of the template is based on a metadata or a semantic context of the one or more documents. In a further implementation, the method includes extracting, by the computing system, metadata of the one or more documents. In another further implementation, the method includes instantiating, by the computing system, a first agent configured to extract and analyze metadata or the semantic context of the one or more documents. In a still further implementation, the method includes generating, by the computing system using the first agent, a prompt for the trained machine learning model. In another still further implementation, the trained machine learning model is executed by a second agent instantiated by the computing system, different from the first agent.

In some implementations, the method includes inserting, by the computing system, one or more internal or external hyperlinks within a document of the one or more documents. In some implementations, the method includes combining, by the computing system, the one or more documents into a consolidated output document.

In another aspect, the present disclosure is directed to a system for automatic generation of navigational elements. The system includes a computing system comprising one or more processors, one or more memory devices storing a plurality of predetermined templates, and one or more network interfaces in communication with a computing device. The one or more processors are configured to: receive, via the one or more network interfaces from the computing device, one or more documents for generation of navigational elements; select a corresponding template for the one or more documents from the plurality of predetermined templates based on a metadata or a semantic context of the one or more documents; generate, via a trained machine learning model, one or more navigation elements for the one or more documents based on the selected template; modify the one or more documents to include the generated one or more navigation elements; and provide, via the one or more network interfaces to the computing device, the modified one or more documents.

In some implementations, the one or more processors are further configured to instantiate a plurality of agents according to the selected template, wherein a first agent is configured to generate the one or more navigation elements, and a second agent is configured to modify the one or more documents to include the one or more navigation elements.

In some implementations, selection of the template is based on a metadata or a semantic context of the one or more documents. In a further implementation, the one or more processors are further configured to extract metadata of the one or more documents. In a still further implementation, the one or more processors are further configured to instantiate a first agent configured to extract and analyze metadata or the semantic context of the one or more documents. In a yet still further implementation, the one or more processors are further configured to generate using the first agent, a prompt for the trained machine learning model. In another yet still further implementation, the trained machine learning model is executed by a second agent instantiated by the computing system, different from the first agent.

In some implementations, the one or more processors are further configured to insert one or more internal or external hyperlinks within a document of the one or more documents. In some implementations, the one or more processors are further configured to combine the one or more documents into a consolidated output document.

In another aspect, the present disclosure is directed to a data processing system for a computer memory. The data processing system includes means for configuring said memory according to a deployable task pipeline, wherein the deployable task pipeline comprises: a first execution agent including a data parser to analyze metadata and content of one or more source documents lacking navigational elements and generate a prompt for a trained machine learning model based on the metadata and content; a second execution agent configured to receive the prompt and content of the one or more source documents and generate one or more navigational elements comprising internal or external hyperlinks using the trained machine learning model; and a third execution agent configured to combine the generated one or more navigational elements and content of the one or more source documents into a consolidated output document comprising the one or more internal or external hyperlinks.

In some implementations, the deployable task pipeline further comprises a fourth execution agent configured to receive the generated one or more navigational elements from the second execution agent, apply one or more filters selected based on the metadata, and generate a prompt for a trained machine learning model of the third execution agent to combine the generated one or more navigational elements and content of the one or more source documents.

### B. Computing Environment

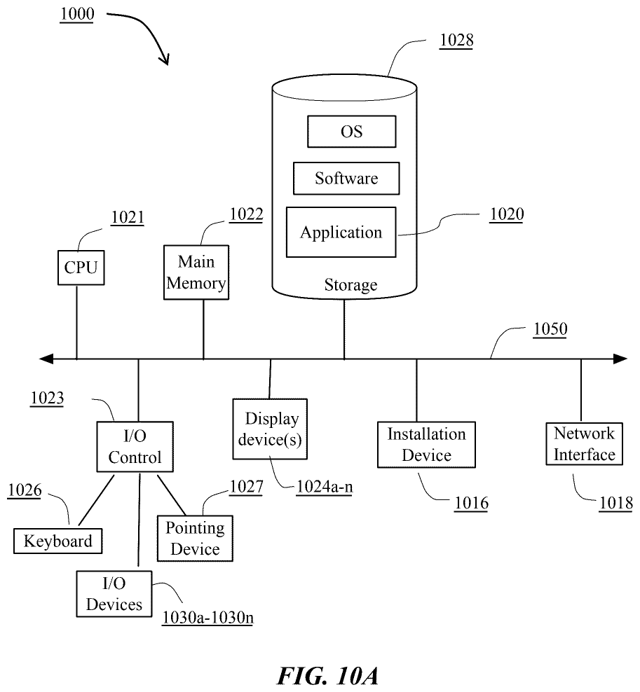

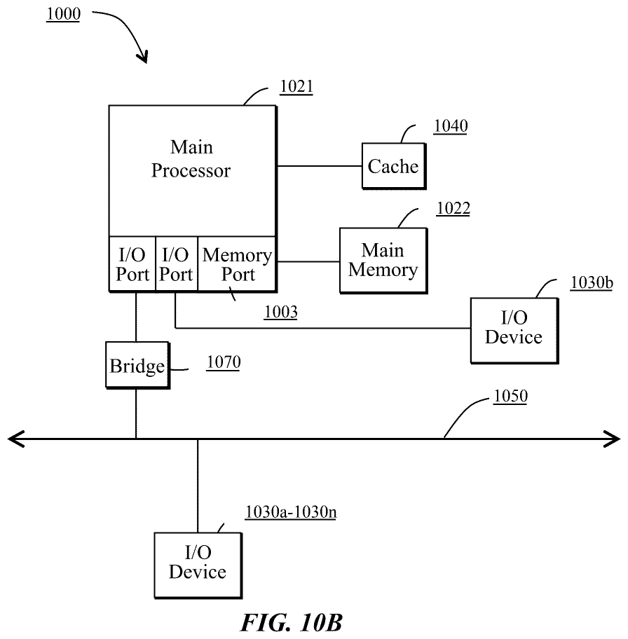

Having discussed specific embodiments of the present solution, it may be helpful to describe aspects of the operating environment as well as associated system components (e.g., hardware elements) in connection with the methods and systems described herein. The systems discussed herein may be deployed as and/or executed on any type and form of computing device, such as a computer, network device, appliance, including virtual computing devices or a virtualized environment (e.g. one or more virtual machines executed by one or more physical computing devices) capable of communicating on any type and form of network and performing the operations described herein. FIGS. 10A and 10B depict block diagrams of a computing device 1000 useful for practicing an embodiment of the wireless communication devices 1002 or the access point 1006. As shown in FIGS. 10A and 10B, each computing device 1000 includes a central processing unit 1021, and a main memory unit 1022. In some implementations, such devices may also include hypervisors and virtualized CPUs for supporting multiple concurrent instances of software components or workloads. As shown in FIG. 10A, a computing device 1000 may include a storage device 1028, an installation device 1016, a network interface 1018, an I/O controller 1023, display devices 1024a-1024n, a keyboard 1026 and a pointing device 1027, such as a mouse. The storage device 1028 may comprise any type and form of storage device, including network or virtualized storage devices, and may allow read and/or write access to data including, without limitation, an operating system, software, or other executable logic. As shown in FIG. 10B, Additionally, each computing device 1000 may also include additional optional elements, such as a memory port 1003, a bridge 1070, one or more input/output devices 1030a-1030n (generally referred to using reference numeral 1030), and a cache memory 1040 in communication with the central processing unit 1021.

The central processing unit 1021 is any logic circuitry that responds to and processes instructions fetched from the main memory unit 1022. In many embodiments, the central processing unit 1021 is provided by a microprocessor unit, such as: those manufactured by Intel Corporation of Mountain View, California; those manufactured by International Business Machines of White Plains, New York; or those manufactured by Advanced Micro Devices of Sunnyvale, California. In virtualized or cloud environments, processors may also include virtualization extensions (e.g., Intel VT-x, AMD-V) to support hypervisors and virtual machines, The computing device 1000 may be based on any of these processors, or any other processor capable of operating as described herein.

Main memory unit 1022 may be one or more memory chips capable of storing data and allowing any storage location to be directly accessed by the microprocessor 1021, such as any type or variant of Static random access memory (SRAM), Dynamic random access memory (DRAM), Ferroelectric RAM (FRAM), NAND Flash, NOR Flash and Solid State Drives (SSD). The main memory 1022 may be based on any of the above described memory chips, or any other available memory chips capable of operating as described herein. In addition, memory may include volatile and non-volatile components managed by modern memory hierarchies optimized for cloud workloads. In the embodiment shown in FIG. 10A, the processor 1021 communicates with main memory 1022 via a system bus 1050 (described in more detail below). FIG. 10B depicts an embodiment of a computing device 1000 in which the processor communicates directly with main memory 1022 via a memory port 1003. For example, in FIG. 10B the main memory 1022 may be DRDRAM.

In some implementations, computing systems may also support cloud-based architectures, enabling distributed memory management across geographically diverse data centers via networked communications.

FIG. 10B depicts an embodiment in which the main processor 1021 communicates directly with cache memory 1040 via a secondary bus, sometimes referred to as a backside bus. In other embodiments, the main processor 1021 communicates with cache memory 1040 using the system bus 1050. Cache memory 1040 typically has a faster response time than main memory 1022 and is provided by, for example, SRAM, BSRAM, or EDRAM. Some systems may integrate processor cache with cloud-optimized memory hierarchies for enhanced performance in virtualized environments. In the embodiment shown in FIG. 10B, the processor 1021 communicates with various I/O devices 1030 via a local system bus 1050. Various buses may be used to connect the central processing unit 1021 to any of the I/O devices 1030, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 1024, the processor 1021 may use an Advanced Graphics Port (AGP) to communicate with the display 1024. Some embodiments may utilize PCIe Gen4 or Gen5 buses for higher bandwidth connections and GPU support for artificial intelligence workloads.

FIG. 10B also depicts an embodiment in which local buses and direct communication are mixed: the processor 1021 communicates with I/O device 1030a using a local interconnect bus while communicating with I/O device 1030b directly. In some embodiments involving cloud-enabled architectures, such communication may also be facilitated via advanced interconnect technologies such as NVLink or CXL (Compute Express Link) to optimize data sharing between CPUs and GPUS.

A wide variety of I/O devices 1030a-1030n may be present in the computing device 1000. Input devices include keyboards, mice, trackpads, trackballs, microphones, dials, touch pads, touch screens, and drawing tablets. Output devices include video displays, speakers, inkjet printers, laser printers, projectors, and dye-sublimation printers. The I/O devices may be controlled by an I/O controller 1023 as shown in FIG. 10A. The VO controller may control one or more I/O devices such as a keyboard 1026 and a pointing device 1027, e.g., a mouse or optical pen. Furthermore, an I/O device may also provide storage and/or an installation medium 1016 for the computing device 1000. In still other embodiments, the computing device 1000 may provide USB connections (not shown) to receive handheld USB storage devices such as the USB Flash Drive line of devices manufactured by Twintech Industry, Inc. of Los Alamitos, California. Some devices may also support Thunderbolt and USB-C connections for faster data transfer and compatibility with external GPUs, storage devices, and displays.

Referring again to FIG. 10A, the computing device 1000 may support any suitable installation device 1016, such as a disk drive, a CD-ROM drive, a CD-R/RW drive, a DVD-ROM drive, a flash memory drive, tape drives of various formats, USB devices, hard drives, a network interface, or any other device suitable for installing software and programs. In cloud environments, installation devices may also include virtualized disk images or containers, enabling the rapid deployment of services and applications. The computing device 1000 may further include a storage device, such as one or more hard disk drives or redundant arrays of independent disks, for storing an operating system and other related software, and for storing application software programs such as any program or software 1020 for implementing (e.g., configured and/or designed for) the systems and methods described herein. Optionally, any of the installation devices 1016 could also be used as the storage device. Additionally, the operating system and the software can be run from a bootable medium. In some cloud-based architectures, such software and operating systems may be deployed dynamically through Infrastructure as a Service (IaaS) platforms, with persistent storage provided by services such as Amazon S3 or Google Cloud Storage.

Furthermore, the computing device 1000 may include a network interface 1018 to interface to the network 1004 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax, and direct asynchronous connections). In some implementations, connections may include support for 5G, LTE, and/or high-speed fiber-optic networks, and/or advanced security protocols such as IPsec or TLS 1.3. In one embodiment, the computing device 1000 communicates with other computing devices 1000′ via any type and/or form of gateway or tunneling protocol such as Secure Socket Layer (SSL) or Transport Layer Security (TLS). The network interface 1018 may include a built-in network adapter, network interface card, PCMCIA network card, card bus network adapter, wireless network adapter, USB network adapter, modem, or any other device suitable for interfacing the computing device 1000 to any type of network capable of communication and performing the operations described herein.

In some implementations, systems may also include support for virtual private networks (VPNs), cloud-based software-defined networking (SDN), and edge computing frameworks to facilitate secure, scalable communication.

In some embodiments, the computing device 1000 may include or be connected to one or more display devices 1024a-1024n. As such, any of the I/O devices 1030a-1030n and/or the I/O controller 1023 may include any type and/or form of suitable hardware, software, or combination of hardware and software to support, enable or provide for the connection and use of the display device(s) 1024a-1024n by the computing device 1000. For example, the computing device 1000 may include any type and/or form of video adapter, video card, driver, and/or library to interface, communicate, connect or otherwise use the display device(s) 1024a-1024n. In one embodiment, a video adapter may include multiple connectors to interface to the display device(s) 1024a-1024n. In other embodiments, the computing device 1000 may include multiple video adapters, with each video adapter connected to the display device(s) 1024a-1024n. In some embodiments, any portion of the operating system of the computing device 1000 may be configured for using multiple displays 1024a-1024n. Some implementations may also support high-resolution displays, including 4K or 8K monitors, and/or virtual reality (VR) or augmented reality (AR) headsets for immersive experiences. Furthermore, advanced GPUs, such as those provided by NVIDIA or AMD, may support AI-enhanced rendering and real-time ray tracing. One ordinarily skilled in the art will recognize and appreciate the various ways and embodiments that a computing device 1000 may be configured to have one or more display devices 1024a-1024n.

In further embodiments, an I/O device 1030 may be a bridge between the system bus 1050 and an external communication bus, such as a USB bus, an Apple Desktop Bus, an RS-232 serial connection, a SCSI bus, a Fire Wire bus, a Fire Wire 800 bus, an Ethernet bus, an AppleTalk bus, a Gigabit Ethernet bus, an Asynchronous Transfer Mode bus, a FibreChannel bus, a Serial Attached Small Computer System Interface bus, a USB connection, or an HDMI bus. Some systems may also incorporate Thunderbolt 4, USB4, and/or DisplayPort technologies, providing high-bandwidth connectivity for peripherals such as external GPUs, NVMe storage devices, and advanced docking stations.

A computing device 1000 of the sort depicted in FIGS. 10A and 10B may operate under the control of an operating system, which controls scheduling of tasks and access to system resources. The computing device 1000 can be running any operating system such as any of the versions of the MICROSOFT WINDOWS operating systems, the different releases of the Unix and Linux operating systems, any version of the MAC OS for Macintosh computers, any embedded operating system, any real-time operating system, any open-source operating system, any proprietary operating system, any operating systems for mobile computing devices, or any other operating system capable of running on the computing device and performing the operations described herein. Operating systems include, but are not limited to: Android, produced by Google Inc. ; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others. In cloud computing environments, operating systems may also include containerized operating environments, such as Kubernetes or Docker, enabling distributed, scalable deployments of microservices.

The computer system 1000 can be any workstation, telephone, desktop computer, laptop or notebook computer, server, handheld computer, mobile telephone or other portable telecommunications device, media playing device, a gaming system, mobile computing device, or any other type and/or form of computing, telecommunications, or media device that is capable of communication. Some computing systems include cloud-based virtual machines, serverless architectures, and/or edge devices designed for IoT applications. The computer system 1000 has sufficient processor power and memory capacity to perform the operations described herein.

In some embodiments, the computing device 1000 may have different processors, operating systems, and input devices consistent with the device. For example, in one embodiment, the computing device 1000 is a smartphone, mobile device, tablet, or personal digital assistant. In still other embodiments, the computing device 1000 is an Android-based mobile device, an iPhone smartphone manufactured by Apple Computer of Cupertino, California, or a Blackberry or WebOS-based handheld device or smartphone, such as the devices manufactured by Research In Motion Limited. In some embodiments, the computing device may be a tablet computing device such as the Apple ipad, Surface devices by Microsoft, or advanced wearable devices such as smartwatches and AR glasses, which operate in conjunction with cloud-based services. Moreover, the computing device 1000 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users,” such “users” may refer to user-associated devices or stations (STAs), for example, consistent with the terms “user” and “multi-user” typically used in the context of a multi-user multiple-input and multiple-output (MU-MIMO) environment. In some embodiments, “users” may also include virtualized clients, software agents, or autonomous systems interfacing through cloud-hosted platforms or distributed networks.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein. Some embodiments of networks may also incorporate advanced wireless communication technologies such as 5G NR, millimeter-wave (mmWave), or satellite-based Internet systems such as Starlink, enabling high-bandwidth and low-latency communications across diverse geographic locations.

It should be noted that certain passages of this disclosure may reference terms such as “first” and “second” in connection with devices, modes of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components, and these components may be provided on either a standalone machine or, in some embodiments, on multiple machines in a distributed system. In cloud architectures, these components may be distributed across virtual machines, containers, or serverless functions within one or more data centers, with orchestration handled by platforms such as Kubernetes, OpenShift, or AWS Lambda. In addition, the systems and methods described above may be provided as one or more computer-readable programs or executable instructions embodied on or in one or more articles of manufacture.

The article of manufacture may be a floppy disk, a hard disk, a CD-ROM, a flash memory card, a PROM, a RAM, a ROM, or a magnetic tape. In general, the computer-readable programs may be implemented in any programming language or framework, including LISP, PERL, C, C++, C #, PROLOG, Python, Go, Rust, JavaScript (e.g., Node.js), or Java. Additionally, software may be developed using frameworks such as TensorFlow or PyTorch for AI workloads, or React and Angular for front-end applications. The software programs or executable instructions may be stored on or in one or more articles of manufacture as object code. Cloud-native applications may also utilize containerized environments, distributed ledgers, or serverless architectures, allowing code to execute dynamically based on predefined triggers and scaling conditions.

In embodiments leveraging software as a service (Saas), the systems may operate entirely in cloud-hosted environments, enabling users to interact through browser-based interfaces or lightweight client applications, and functionality may be delivered over a network such as the Internet without requiring installation on local devices.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

1. A method for automatic generation of navigational elements, comprising:
receiving, by a computing system from a computing device, one or more documents for generation of navigational elements;
selecting, by the computing system, a corresponding template for the one or more documents from a plurality of predetermined templates;
instantiating, by the computing system, a plurality of agents according to the selected template;
generating, by a first agent of the plurality of agents instantiated by the computing system via a trained machine learning model, one or more navigation elements for the one or more documents based on the selected template;
modifying, by a second agent of the plurality of agents instantiated by the computing system different from the first agent, the one or more documents to include the generated one or more navigation elements; and
providing, by the computing system to the computing device, the modified one or more documents.

2. (canceled)

3. The method of claim 1, wherein selection of the template is based on a metadata or a semantic context of the one or more documents.

4. The method of claim 3, further comprising extracting, by the computing system, metadata of the one or more documents.

5. The method of claim 3, further comprising instantiating, by the computing system, a first agent configured to extract and analyze metadata or the semantic context of the one or more documents.

6. The method of claim 5, further comprising generating, by the computing system using the first agent, a prompt for the trained machine learning model.

7. The method of claim 5, wherein the trained machine learning model is executed by a second agent instantiated by the computing system, different from the first agent.

8. The method of claim 1, wherein modifying the one or more documents to include the generated one or more navigation elements further comprises inserting, by the computing system, one or more internal or external hyperlinks within a document of the one or more documents.

9. The method of claim 1, further comprising combining, by the computing system, the one or more documents into a consolidated output document.

10. A system for automatic generation of navigational elements, comprising:
a computing system comprising one or more processors, one or more memory devices storing a plurality of predetermined templates, and one or more network interfaces in communication with a computing device;
wherein the one or more processors are configured to:
receive, via the one or more network interfaces from the computing device, one or more documents for generation of navigational elements,
select a corresponding template for the one or more documents from the plurality of predetermined templates based on a metadata or a semantic context of the one or more documents,
instantiate a plurality of agents according to the selected template,
generate, using a first agent of the plurality of agents via a trained machine learning model, one or more navigation elements for the one or more documents based on the selected template,
modify, using a second agent of the plurality of agents, the one or more documents to include the generated one or more navigation elements, and
provide, via the one or more network interfaces to the computing device, the modified one or more documents.

11. (canceled)

12. The system of claim 10, wherein selection of the template is based on a metadata or a semantic context of the one or more documents.

13. The system of claim 12, wherein the one or more processors are further configured to extract metadata of the one or more documents.

14. The system of claim 13, wherein the one or more processors are further configured to instantiate a first agent configured to extract and analyze metadata or the semantic context of the one or more documents.

15. The system of claim 14, wherein the one or more processors are further configured to generate, using the first agent, a prompt for the trained machine learning model.

16. The system of claim 14, wherein the trained machine learning model is executed by a second agent instantiated by the computing system, different from the first agent.

17. The system of claim 10, wherein the one or more processors are further configured to insert one or more internal or external hyperlinks within a document of the one or more documents.

18. The system of claim 10, wherein the one or more processors are further configured to combine the one or more documents into a consolidated output document.

19. A data processing system for a computer memory, comprising:
means for configuring said memory according to a deployable task pipeline, wherein the deployable task pipeline comprises:
a first execution agent including a data parser to analyze metadata and content of one or more source documents lacking navigational elements and generate a prompt for a trained machine learning model based on the metadata and content;
a second execution agent configured to receive the prompt and content of the one or more source documents and generate one or more navigational elements comprising internal or external hyperlinks using the trained machine learning model; and
a third execution agent configured to combine the generated one or more navigational elements and content of the one or more source documents into a consolidated output document comprising the one or more internal or external hyperlinks.

20. The data processing system of claim 19, wherein the deployable task pipeline further comprises a fourth execution agent configured to receive the generated one or more navigational elements from the second execution agent, apply one or more filters selected based on the metadata, and generate a prompt for a trained machine learning model of the third execution agent to combine the generated one or more navigational elements and content of the one or more source documents.

21. The data processing system of claim 20, wherein the first execution agent is configured to generate the prompt for a first trained machine learning model; and wherein the fourth execution agent is configured to generate the prompt for a second trained machine learning model, different from the first trained machine learning model.

22. The data processing system of claim 19, wherein the means for configuring said memory further comprises means for selecting the first execution agent, second execution agent, and third execution agent from a plurality of execution agents based on the one or more source documents.
